(19) United States
(12) Patent Application Publication
(10) Pub. No.: US 2008/0136597 A1
(43) Pub. Date: Jun. 12, 2008

(54) RFID SENSOR TAG ANTENNA USING COUPLING FEEDING METHOD

(75) Inventors: Won Kyu CHOI, Daejeon-city (KR); Hae Won Son, Daejeon-city (KR); Jae-Young Jung, Daejeon-city (KR); Junho Yeo, Daejeon-city (KR); Gil Young Choi, Daejeon-city (KR); Cheol Sig Pyo, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon-city (KR)

(21) Appl. No.: 11/936,022

(22) Filed: Nov. 6, 2007

(30) Foreign Application Priority Data
Dec. 8, 2006 (KR) 10-2006-0125036

(51) Int. Cl. H04B 7/00

(52) U.S. Cl. 340/10.1

(57) ABSTRACT

Provided is a radio frequency identification (RFID) sensor tag antenna using an aperture coupling feeding method, including: a radiation patch for determining a resonance frequency of the RFID sensor tag antenna, which is disposed in an uppermost portion of the RFID sensor tag antenna; a first dielectric layer disposed on a bottom surface of the radiation patch and interposed between the radiation patch and a ground layer disposed to be parallel with the radiation patch; and a slot formed in a side of the ground layer and coupling RF signals to the RFID sensor tag antenna. Thus, the RFID sensor tag antenna can separately adjust resistance and reactance components of input impedance. As a result, the RFID sensor tag antenna can be matched with an RFID sensor tag board without an additional matching circuit.

### CROSS-REFERENCE TO RELATED PATENT APPLICATION

This application claims the benefit of Korean Patent Application No. 10-2006-0125036, filed on Dec. 8, 2006, in the Korean Intellectual Property Office, the disclosure of which is incorporated herein in its entirety by reference.

### BACKGROUND OF THE INVENTION

1. Field of the Invention

The present invention relates to a radio frequency identification (RFID) sensor tag antenna using an aperture coupling feeding method, and more particularly, to a platform-insensitive sensor tag antenna having an aperture coupling feeding structure and capable of uniformly maintaining characteristics of sensor tags regardless of variations in a material to which the sensor tags are attached.

This work was supported by the IT R&D program of MIC/IITA [2005-S-106-02, Development of Sensor Tag and Sensor Node Technologies for RFID/USN]

2. Description of the Related Art

Radio frequency identification (RFID) sensor tags are semi-passive and have additional power sources differently from passive RFID tags. Power sources of RFID sensor tags are used for driving tag circuits and communicate with readers using a back scattering modulation method such as RFID.

Back scattering modulation refers to a method by which a tag scatters electromagnetic waves transmitted from a reader, modulates the amplitude or phase of the electromagnetic waves, and transmits information from the reader so as to re-transmit the electromagnetic waves. Semi-passive sensor tags may be used in various kinds of applications according to types of sensors. A sensor tag of the present invention may include a temperature sensor to monitor blood, food, environments of animals/plants, and physical distribution.

For example, a temperature sensor tag senses variations in the surrounding temperature, stores temperature information in an internal memory, and wirelessly provides the temperature information to an RFID sensor tag reader positioned within a range of between 5 m and 10 m for a request to the RFID sensor tag reader.

In general, semi-passive sensor tags can be classified into film and board types, i.e., dipole and monopole antenna types. Thus, a resonance frequency and radiation efficiency may be changed according to an attached object. As a result, an antenna type may be changed according to an application to which a sensor tag is attached, which may be a factor limiting the use of the sensor tag.

Also, a general board type sensor tag includes an additional matching circuit between an antenna and a radio frequency (RF) front-end so as to maximize the intensity of a signal transmitted from the antenna to the RF front-end. However, the matching circuit is formed of a combination of a capacitor and an inductor and thus may cause loss.

### SUMMARY OF THE INVENTION

The present invention provides a micro-strip patch antenna having an aperture coupling feeding structure and a planar inverted-F antenna (PIFA).

The present invention also provides a sensor tag antenna which can separate a radio frequency (RF) front end including a radiation patch and a signal processor from a ground surface layer using a micro-strip patch antenna and a PIFA to reduce interference between the RF front end and the ground plate, increase the flexibility of design of the RF front end and the ground surface layer, and allow the radiation patch and the ground surface layer to maintain predetermined distances from an object to which sensor tags are attached to reduce variations in characteristics of the sensor tag antenna caused by variations in the object.

The present invention also provides a radio frequency identification (RFID) sensor tag antenna capable of independently adjusting resistance and reactance components of input impedance of an RF front end of an RFID sensor tag to match the RFID sensor tag antenna with the RF front end without an additional matching circuit.

The present invention also provides a platform-insensitive antenna having characteristics (return loss, a resonance frequency, etc.) slightly varying depending on variations in an attached object (metal, plastic, or wood) and a method of feeding power to the platform-insensitive antenna to efficiently match the platform-insensitive antenna with an RF front end without an additional matching circuit.

According to an aspect of the present invention, there is provided an RFID sensor tag antenna using an aperture coupling feeding method, comprising: a radiation patch for determining a resonance frequency of the RFID sensor tag antenna, which is disposed in an uppermost portion of the RFID sensor tag antenna; a first dielectric layer disposed on a bottom surface of the radiation patch and interposed between the radiation patch and a ground layer disposed to be parallel with the radiation patch; and a slot formed in a side of the ground layer and coupling RF signals to the RFID sensor tag antenna.

A dielectric material or a thickness of the first dielectric layer is adjusted in consideration of a bandwidth or radiation efficiency of the RFID sensor tag antenna.

A size or a shape of the slot is adjusted in consideration of an amount of coupling of the RF signals.

The RF sensor tag antenna further includes: a second dielectric layer disposed on a bottom surface of the ground layer; and a micro-strip line disposed on a bottom surface of the second dielectric layer, wherein an end of the micro-strip line is opened or short-circuited.

A slot or a slit is formed in the radiation patch to adjust the resonance frequency or a size of the RFID sensor tag antenna.

The ground layer is maintained a predetermined height from a bottom of the RFID sensor tag antenna.

Analog and digital circuits or a power source unit are disposed on a bottom surface of the ground layer so as to separate the radiation patch from the bottom of the RFID sensor tag.

According to another aspect of the present invention, there is provided an RFID sensor tag antenna using an aperture coupling feeding method, comprising: a radiation patch determining a resonance frequency of the RFID sensor tag antenna and disposed in an uppermost portion of the RFID sensor tag antenna; a dielectric layer disposed on a bottom surface of the radiation patch and interposed between the radiation patch and a ground layer disposed to be parallel with the radiation patch; a short-circuit plate connecting the radiation patch to the ground layer; and a slot formed in a side of the ground layer and coupling RF signals to the RFID sensor tag antenna.

A dielectric material or a thickness of the dielectric layer is adjusted in consideration of a bandwidth and radiation efficiency of the RFID sensor tag antenna.

A size or a shape of the slot is adjusted in consideration of an amount of coupling of the RF signals.

The RFID sensor tag antenna further comprises: a second dielectric layer disposed on a bottom surface of the ground layer; and a micro-strip line disposed on a bottom surface of the second dielectric layer, wherein an end of the micro-strip line is opened or short-circuited.

A slot or a slit is formed in the radiation patch to adjust the resonance frequency or a size of the RFID sensor tag antenna.

The ground layer is maintained a predetermined height from a bottom of the RFID sensor tag antenna.

Analog and digital circuits or a power source unit are disposed on a bottom surface of the ground layer so as to space the radiation patch apart from the bottom of the RFID sensor tag.

An inductive reactance component of input impedance of the RFID sensor tag antenna is increased by short-circuiting the end of the micro-strip line, and a capacitive reactance component of the input impedance is increased by opening the end of the micro-strip line.

An inductive or a capacitive reactance component of the input impedance is adjusted by varying a length of the micro-strip line.

A resistance component of the input impedance is reduced by reducing a width and a length of the slot, and the resistance component of the input impedance is increased by increasing the width and the length of the slot.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view illustrating a conventional micro-strip patch antenna using an aperture coupling feeding method;

FIG. 2 is a perspective view illustrating a conventional planar inverted-F antenna (PIFA);

FIG. 3 is a perspective view illustrating a platform-insensitive micro-strip patch antenna using an aperture coupling feeding method according to an embodiment of the present invention;

FIG. 4 is a Smith chart illustrating variations in an inductive reactance caused by variations in a length of a micro-strip line of a sensor tag antenna according to an embodiment of the present invention;

FIG. 5 is a Smith chart illustrating variations in a resistance caused by variations in a length of a slot of a ground layer of a sensor tag antenna according to an embodiment of the present invention;

FIG. 6 is a perspective view illustrating a platform-insensitive inverted-F antenna using an aperture coupling feeding method according to an embodiment of the present invention;

FIG. 7 is a graph illustrating variations in return loss depending on an object (wood, plastic, or metal) to which a sensor tag antenna is attached, according to an embodiment of the present invention; and

FIG. 8 is a Smith chart illustrating variations in impedance depending on an object (wood, plastic, or metal) to which a sensor tag antenna is attached, according to an embodiment of the present invention.

### DETAILED DESCRIPTION OF THE INVENTION

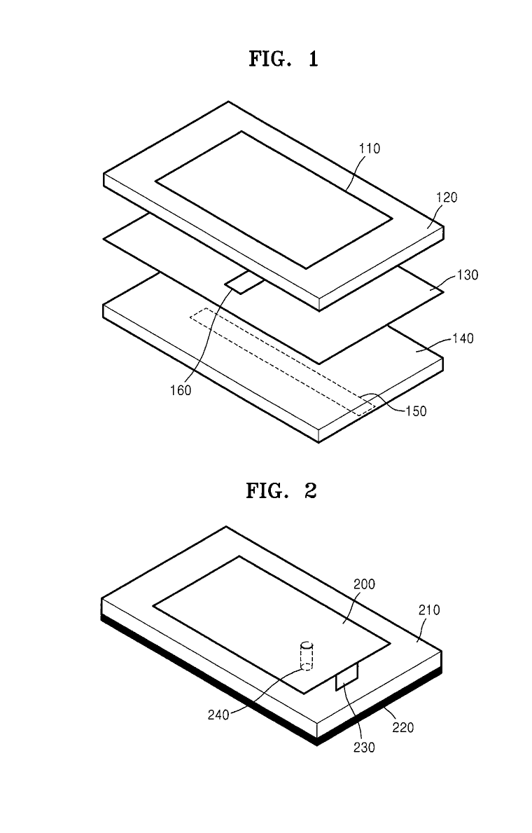

The present invention will now be described more fully with reference to the accompanying drawings, in which exemplary embodiments of the invention are shown. FIG. 1 is an exploded perspective view illustrating the structure of a conventional micro-strip patch antenna using an aperture coupling feeding method. Referring to FIG. 1, the conventional micro-strip patch antenna includes a radiation patch 110 for electromagnetic wave radiation, a first dielectric layer 120, a ground layer 130, a second dielectric layer 140 for micro-strip feeding, a micro-strip line 150 for antenna feeding, and a slot 160 for electromagnetic wave coupling.

The radiation patch 110 for electromagnetic wave radiation is disposed on the first dielectric layer 120, and the ground layer 130 is disposed on a bottom surface of the first dielectric layer 120.

The slot 160 for electromagnetic wave coupling is formed in the ground layer 130, and the second dielectric layer 140 for micro-strip feeding is disposed on a bottom surface of the ground layer 130. The micro-strip line 150 for antenna feeding is disposed on a bottom surface of the second dielectric layer 140.

FIG. 2 is a perspective view illustrating a conventional planar inverted-F antenna (PIFA). Referring to FIG. 2, the PIFA includes a radiation patch 200, a dielectric layer 210, a ground layer 220, a short-circuit plate 230, and a coaxial cable 240.

The radiation patch 200 is disposed on and supported by the dielectric layer 210, and the ground layer 220 is disposed on a bottom surface of the dielectric layer 210.

The radiation patch 200 and the ground layer 220 are short-circuited by the short-circuit plate 230. The coaxial cable 240 may be used to supply power to the conventional PIFA.

Input impedance of the conventional PIFA depends on an area of the short-circuit plate 230 and a feeding position of the coaxial cable 240.

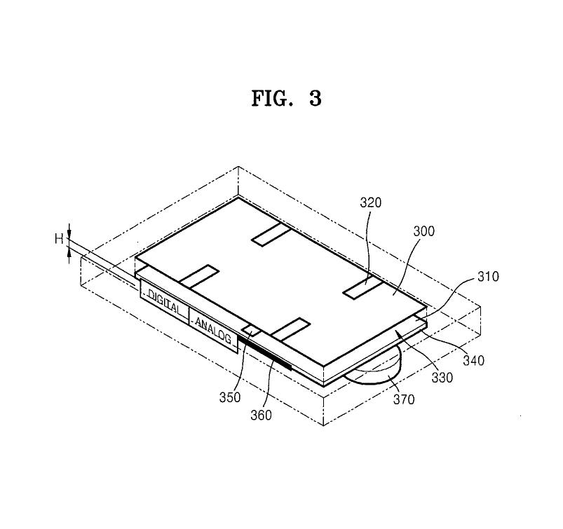

FIG. 3 is a perspective view illustrating a platform-insensitive micro-strip patch antenna using an aperture coupling feeding method according to an embodiment of the present invention. Referring to FIG. 3, the platform-insensitive micro-strip patch antenna according to the current embodiment of the present invention includes a radiation patch 300, a first dielectric layer 310, slots or slits 320, a ground layer 330, a second dielectric layer 340, a slot 350, a micro-strip line 360, and a power source unit 370.

In the platform-insensitive micro-strip patch antenna according to the current embodiment of the present invention, the ground layer 330 is disposed to be parallel with the radiation patch 300, and the first dielectric layer 310 for the radiation patch 300 is interposed between the radiation patch 300 and the ground layer 330.

The first dielectric layer 310 may be formed of a dielectric having various dielectric constants in consideration of a bandwidth and radiation efficiency of the platform-insensitive micro-strip patch antenna. The slots or slits 320 may be formed in the radiation patch 300 to adjust a resonance frequency or reduce a size of the platform-insensitive micro-strip patch antenna.

The slot 350 for radio frequency (RF) signal coupling is formed in the ground layer 330 disposed on a bottom surface of the first dielectric layer 310. The second dielectric layer 340 is disposed on a bottom surface of the ground layer 330 and includes analog and digital circuits and the micro-strip line 360. The power source unit 370 for sensor tag driving is mounted on the second dielectric layer 340.

The micro-strip line 360 is disposed on a bottom surface of the second dielectric layer 340 so as to be positioned underneath the slot 350 disposed in the ground layer 330.

The platform-insensitive micro-strip patch antenna according to the current embodiment of the present invention is complex conjugate-matched with an RF front end of an RFID sensor tag without an additional matching circuit. The micro-strip line 360 and the slot 350 formed in the ground surface layer 330 are parameters which are mainly used for this purpose.

Lengths and shapes of the micro-strip line 360 and the slot 350 may depend on input impedance of the RF front end of the of the RFID sensor tag. The micro-strip line 360 may be used to adjust a reactance component of the input impedance, and the slot 350 may be used to adjust a resistance component of the input impedance.

Also, when an RF front end of a sensor tag has a capacitance reactance component, it is advantageous to short an end of the micro-strip line 360 so as to make the input impedance into an inductance reactance component. When the RF front end has an inductance reactance component, it is advantageous to open the end of the micro-strip line 360 so as to make the input impedance into a capacitance reactance component.

In other words, it is advantageous to short the end of the micro-strip line 360 and adjust a length of the micro-strip line 360 so as to adjust an inductive reactance value of the input impedance of the platform-insensitive micro-strip patch antenna. It is advantageous to open the micro-strip line 360 and adjust the length of the micro-strip line 360 so as to adjust the capacitive reactance value.

Also, the slot 350 is used to adjust a resistance of the input impedance. If a width and the length of the slot 350 are decreased, a coupled amount of the RF signals is decreased, and thus the resistance is reduced. If the width and the length of the slot 350 are increased, the coupled amount of the RF signals is increased, and thus the resistance is increased.

In addition, since the radiation patch 300 is insulated from the micro-strip line 360 and the power source unit 370 by the ground layer 330, interference is reduced, and space utility is optimized.

The radiation patch 300 and the ground layer 330 can be separated from a bottom of the RFID sensor tag antenna by heights of the micro-strip line 360 and the power source unit 370. Thus, an effect of an object to which the RFID sensor tag antenna is attached, on the platform-sensitive micro-strip patch antenna can be minimized.

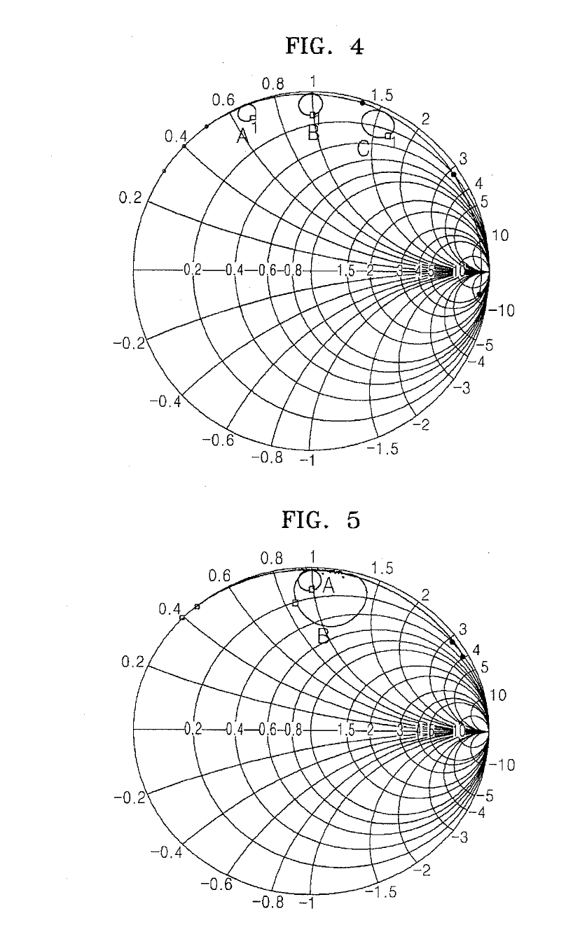

FIG. 4 is a Smith chart illustrating variations in an inductive reactance caused by variations in a length of a micro-strip line of a sensor tag antenna according to an embodiment of the present invention.

The sensor tag antenna was designed to have an inductive reactance component on the assumption that input impedance of an RF front end of the sensor tag has a strong capacitive reactance component.

Referring to FIG. 4, when the length of the micro-strip line 360 of FIG. 3 is increased three times by distances of 5 mm each time, an inductive reactance value is increased in order of A, B, and C.

FIG. 5 is a Smith chart illustrating variations in a resistance caused by variations in a length of a slot formed in a ground layer of a sensor tag antenna according to an embodiment of the present invention.

Referring to FIG. 5, when a size of the slot 350 formed in the ground layer 330 of FIG. 3 is increased, a resistance of the sensor tag antenna is increased.

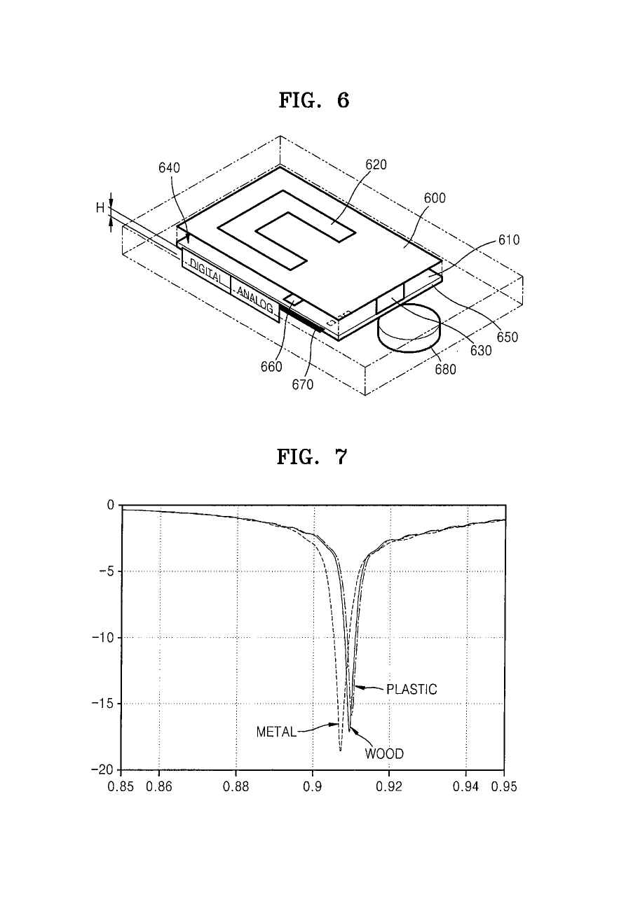

FIG. 6 is a perspective view illustrating a platform-insensitive inverted-F antenna using an aperture coupling feeding method, according to an embodiment of the present invention. Referring to FIG. 6, the platform-insensitive inverted-F antenna according to the current embodiment of the present invention includes a radiation patch 600, a first dielectric layer 610, a slot or slit 620, a short-circuit plate 630, a ground layer 640, a second dielectric layer 650, a slot 660 for coupling RF signals, a micro-strip line 670, and a power source unit 680.

In the platform-insensitive inverted-F antenna according to the current embodiment of the present invention, the radiation patch 600 is disposed to be parallel with the ground layer 640, and the first dielectric layer 610 is interposed between the radiation patch 600 and the ground surface layer 640.

The first dielectric layer 610 may be formed of a dielectric having a dielectric constant which varies in consideration of a bandwidth and radiation efficiency of the platform-insensitive inverted-F antenna. The slot or slit 620 may be formed in the radiation patch 600 to adjust a resonance frequency and reduce a size of the platform-insensitive inverted-F antenna.

The ground layer 640 is disposed on a bottom surface of the first dielectric layer 610, and the slot 660 for coupling RF signals is formed in the ground layer 640. The second dielectric layer 650 is disposed on a bottom surface of the ground layer 640 and includes analog and digital circuits. The slot or slit 620 is formed in the radiation patch 600. The power source unit 680 is formed on a bottom surface of the second dielectric layer 650 to drive a sensor tag.

The micro-strip line 670 is disposed on a bottom surface of the second dielectric layer 650 is positioned underneath the slot 660 formed in the ground layer 640. The radiation patch 600 and the ground layer 640 are short-circuited by the short-circuit plate 630 to realize the platform-insensitive inverted-F antenna.

The shape and position of the short-circuit plate 630 may be variously designed to adjust the resonance frequency and impedance.

An impedance adjusting method and characteristics of the platform-insensitive inverted-F antenna of FIG. 6 are the same as those of the platform-insensitive micro-strip patch antenna of FIG. 3, and thus descriptions thereof will not be repeated.

FIG. 7 is a graph illustrating variations in return loss depending on an object (wood, plastic, or metal) to which a sensor tag antenna is attached, according to an embodiment of the present invention.

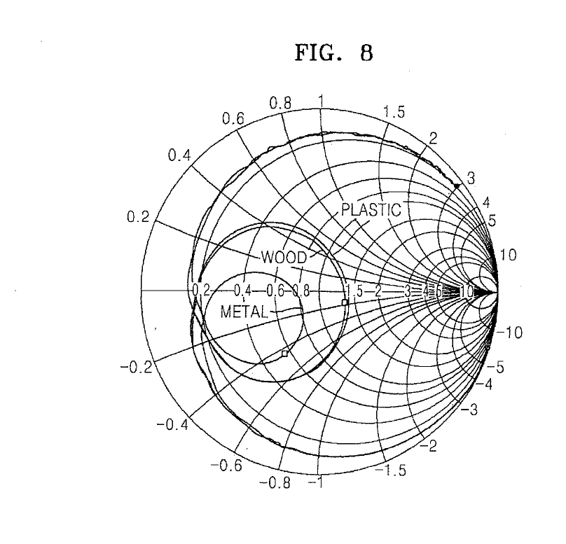

FIG. 8 is a Smith chart illustrating variations in impedance depending on an object (wood, plastic, or metal) to which a sensor tag antenna is attached, according to an embodiment of the present invention.

Characteristics of the platform-insensitive inverted-F antenna of FIG. 6 are illustrated in FIGS. 7 and 8. In particular, FIG. 8 is a Smith chart regularizing a resistance of input impedance of the sensor tag. In the Smith chart illustrated in FIG. 8, the input impedance varies with respect to variations in frequency.

Referring to FIGS. 7 and 8, irrespective of whether the object is wood, plastic, or metal, a resonance frequency and the input impedance of the platform-insensitive inverted-F antenna hardly vary.

As described above, an RFID sensor tag antenna according to the present invention can be a micro-strip patch antenna using an aperture coupling feeding method and an inverted-F antenna. Thus, the RFID sensor tag antenna can be matched with impedance of an RF front end without an additional matching circuit.

In addition, a radiation patch and a common ground surface layer can maintain predetermined distances from an attached object. Thus, a platform-insensitive sensor tag can be provided so as to slightly vary characteristics of the RFID sensor tag antenna depending on variations in the attached object.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A radio frequency identification (RFID) sensor tag antenna using an aperture coupling feeding method, comprising:
a radiation patch for determining a resonance frequency of the RFID sensor tag antenna, which is disposed in an uppermost portion of the RFID sensor tag antenna;
a first dielectric layer disposed on a bottom surface of the radiation patch and interposed between the radiation patch and a ground layer disposed to be parallel with the radiation patch; and
a slot formed in a side of the ground layer and coupling RF signals to the RFID sensor tag antenna.

2. The RFID sensor tag antenna of claim 1, wherein a dielectric material or a thickness of the first dielectric layer is adjusted in consideration of a bandwidth or radiation efficiency of the RFID sensor tag antenna.

3. The RFID sensor tag antenna of claim 1, wherein a size or a shape of the slot is adjusted in consideration of an amount of coupling of the RF signals.

4. The RF sensor tag antenna of claim 1, further comprising:
a second dielectric layer disposed on a bottom surface of the ground layer; and
a micro-strip line disposed on a bottom surface of the second dielectric layer, wherein an end of the micro-strip line is opened or short-circuited.

5. The RFID sensor tag antenna of claim 1, wherein a slot or a slit is formed in the radiation patch to adjust the resonance frequency or a size of the RFID sensor tag antenna.

6. The RFID sensor tag antenna of claim 1, wherein the ground layer is maintained a predetermined height from a bottom of the RFID sensor tag antenna.

7. The RFID sensor tag antenna of claim 1, wherein analog and digital circuits or a power source unit are disposed on a bottom surface of the ground layer so as to separate the radiation patch from the bottom of the RFID sensor tag.

8. An RFID sensor tag antenna using an aperture coupling feeding method, comprising:
a radiation patch determining a resonance frequency of the RFID sensor tag antenna and disposed in an uppermost portion of the RFID sensor tag antenna;
a dielectric layer disposed on a bottom surface of the radiation patch and interposed between the radiation patch and a ground layer disposed to be parallel with the radiation patch;
a short-circuit plate connecting the radiation patch to the ground layer; and
a slot formed in a side of the ground layer and coupling RF signals to the RFID sensor tag antenna.

9. The RFID sensor tag antenna of claim 8, wherein a dielectric material or a thickness of the dielectric layer is adjusted in consideration of a bandwidth and radiation efficiency of the RFID sensor tag antenna.

10. The RFID sensor tag antenna of claim 8, wherein a size or a shape of the slot is adjusted in consideration of an amount of coupling of the RF signals.

11. The RFID sensor tag antenna of claim 8, further comprising:
a second dielectric layer disposed on a bottom surface of the ground layer; and
a micro-strip line disposed on a bottom surface of the second dielectric layer, wherein an end of the micro-strip line is opened or short-circuited.

12. The RFID sensor tag antenna of claim 8, wherein a slot or a slit is formed in the radiation patch to adjust the resonance frequency or a size of the RFID sensor tag antenna.

13. The RFID sensor tag antenna of claim 8, wherein the ground layer is maintained a predetermined height from a bottom of the RFID sensor tag antenna.

14. The RFID sensor tag antenna of claim 8, wherein analog and digital circuits or a power source unit are disposed on a bottom surface of the ground layer so as to space the radiation patch apart from the bottom of the RFID sensor tag.

15. The RFID sensor tag antenna of claim 4, wherein an inductive reactance component of input impedance of the RFID sensor tag antenna is increased by short-circuiting the end of the micro-strip line, and a capacitive reactance component of the input impedance is increased by opening the end of the micro-strip line.

16. The RFID sensor tag antenna of claim 15, wherein an inductive or a capacitive reactance component of the input impedance is adjusted by varying a length of the micro-strip line.

17. The RFID sensor tag antenna of claim 4, wherein a resistance component of the input impedance is reduced by reducing a width and a length of the slot, and the resistance component of the input impedance is increased by increasing the width and the length of the slot.
